(19) United States
(12) Patent Application Publication
(10) Pub. No.: US 2013/0105416 A1
(43) Pub. Date: May 2, 2013

(54) DEBRIS FILTERING APPARATUS AND METHOD

(71) Applicants: Brian Robert Whitehead, Red Deer (CA); Scott Douglas Odegard, Red Deer (CA)

(72) Inventors: Brian Robert Whitehead, Red Deer (CA); Scott Douglas Odegard, Red Deer (CA)

(73) Assignee: IROC ENERGY SERVICES PARTNERSHIP, Red Deer, AB (CA)

(21) Appl. No.: 13/697,458

(22) PCT Filed: Jun. 11, 2010
(86) PCT No.: PCT/CA2010/000882

§ 371 Date: Dec. 21, 2012

(51) Int. Cl. B01D 35/02

(52) U.S. Cl. CPC B01D 35/02
USPC 210/806; 210/348; 210/323.1; 210/254; 210/767

(57) ABSTRACT

A debris filtering apparatus and method. The apparatus includes a first filter assembly. The first filter assembly includes an outer conduit and an inner conduit received within the outer conduit. An inner conduit flow-path is defined within the inner conduit and an outer conduit flowpath is defined between the inner conduit and the outer conduit. The inner conduit includes a filter. A fluid inlet is in communication with the inner conduit flowpath and a fluid outlet is in communication with the outer conduit flowpath. The filter permits a fluid to pass between the inner conduit flowpath and the outer conduit flowpath while retaining debris within the inner conduit. The method includes passing the fluid through the first filter assembly, removing the inner conduit from within the outer conduit, removing the debris from the inner conduit, and replacing the inner conduit within the outer conduit.

### TECHNICAL FIELD

An apparatus and a method for filtering debris from a fluid.

### BACKGROUND OF THE INVENTION

Various fluids may be passed through a wellbore in the course of drilling, completing, testing, treating and producing fluids from the wellbore.

During drilling, drilling fluid may be circulated through the wellbore. During completion, fluids associated with completing the wellbore may be passed through the wellbore. During testing, fluids associated with testing the wellbore may be passed through the wellbore. During treating, fluids associated with treating the wellbore may be passed through the wellbore. During production, hydrocarbons, water and other fluids may be produced from the wellbore.

These various fluids may contain or may pick up debris such as solid particles as they pass through the wellbore. This debris may be detrimental to equipment associated with the wellbore. For example, the flow of fluids from a wellbore may be controlled with the assistance of a choke. The presence of debris in a fluid which passes through a choke may plug the choke and/or cause the choke to malfunction.

It is therefore desirable to filter debris from a fluid which may be passed through a wellbore in order to remove debris from the fluid.

### SUMMARY OF THE INVENTION

References in this document to orientations, to operating parameters, to ranges, to lower limits of ranges, and to upper limits of ranges are not intended to provide strict boundaries for the scope of the invention, but should be construed to mean “approximately” or “about” or “substantially”, within the scope of the teachings of this document, unless expressly stated otherwise.

The present invention is directed at an apparatus and a method for filtering debris from a fluid. The apparatus and method of the invention may be used to filter debris from a fluid which has been passed through a wellbore.

In a first exemplary apparatus aspect, the invention is an apparatus for filtering debris from a fluid, the apparatus comprising:

(a) a first filter assembly, wherein the first filter assembly comprises:
(i) an outer conduit having an outer conduit sidewall and an inner surface defined by the outer conduit sidewall;
(ii) an inner conduit having an inner conduit sidewall and an outer surface defined by the inner conduit sidewall, wherein the inner conduit is received within the outer conduit so that an inner conduit flowpath is defined within the inner conduit and an outer conduit flowpath is defined between the outer surface of the inner conduit sidewall and the inner surface of the outer conduit sidewall, and wherein the inner conduit sidewall is comprised of a filter which permits the fluid to pass between the inner conduit flowpath and the outer conduit flowpath;
(iii) a fluid inlet in communication with the inner conduit flowpath; and
(iv) a fluid outlet in communication with the outer conduit flowpath.

In some embodiments, the outer conduit flowpath of the first filter assembly may be blocked in order to prevent communication between the fluid inlet and the outer conduit flowpath. In some embodiments, the inner conduit flowpath of the first filter assembly may be blocked in order to prevent communication between the fluid outlet and the inner conduit flowpath.

The filter of the first filter assembly may be comprised of any structure, device or apparatus which is suitable for providing a filtering function. In some embodiments, the filter of the first filter assembly may be configured to retain an amount of the debris within the inner conduit as the fluid passes from the inner conduit flowpath to the outer conduit flowpath.

In some embodiments, the first filter assembly may have an inlet end and an outlet end. In some embodiments, the fluid inlet of the first filter assembly may be associated with the inlet end of the first filter assembly. In some embodiments, the fluid outlet of the first filter assembly may be associated with the outlet end of the first filter assembly.

In some embodiments, the inlet end of the first filter assembly may be comprised of a first filter assembly inlet manifold. In some embodiments, the outlet end of the first filter assembly may be comprised of a first filter assembly outlet manifold.

In some embodiments, the apparatus may be further comprised of a second filter assembly. In some embodiments, the second filter assembly may comprise:
(i) an outer conduit having an outer conduit sidewall and an inner surface defined by the outer conduit sidewall;
(ii) an inner conduit having an inner conduit sidewall and an outer surface defined by the inner conduit sidewall, wherein the inner conduit is received within the outer conduit so that an inner conduit flowpath is defined within the inner conduit and an outer conduit flowpath is defined between the outer surface of the inner conduit sidewall and the inner surface of the outer conduit sidewall, and wherein the inner conduit sidewall is comprised of a filter which permits the fluid to pass between the inner conduit flowpath and the outer conduit flowpath;
(iii) a fluid inlet in communication with the inner conduit flowpath; and
(iv) a fluid outlet in communication with the outer conduit flowpath.

In some embodiments, the outer conduit flowpath of the second filter assembly may be blocked in order to prevent communication between the fluid inlet and the outer conduit flowpath. In some embodiments, the inner conduit flowpath of the second filter assembly may be blocked in order to prevent communication between the fluid outlet and the inner conduit flowpath.

The filter of the second filter assembly may be comprised of any structure, device or apparatus which is suitable for providing a filtering function. In some embodiments, the filter of the second filter assembly may be configured to retain an amount of the debris within the inner conduit as the fluid passes from the inner conduit flowpath to the outer conduit flowpath.

In some embodiments, the second filter assembly may have an inlet end and an outlet end. In some embodiments, the fluid inlet of the second filter assembly may be associated with the inlet end of the second filter assembly. In some embodiments, the fluid outlet of the second filter assembly may be associated with the outlet end of the second filter assembly.

In some embodiments, the inlet end of the second filter assembly may be comprised of a second filter assembly inlet manifold. In some embodiments, the outlet end of the second filter assembly may be comprised of a second filter assembly outlet manifold.

In some embodiments, the apparatus may be further comprised of a bypass assembly. In some embodiments, the bypass assembly may comprise:

(a) a bypass conduit defining a bypass flowpath;

(b) a fluid inlet in communication with the bypass flowpath; and

(c) a fluid outlet in communication with the bypass flowpath.

In some embodiments, the bypass assembly may have an inlet end and an outlet end. In some embodiments, the fluid inlet of the bypass assembly may be associated with the inlet end of the bypass assembly. In some embodiments, the fluid outlet of the bypass assembly may be associated with the outlet end of the bypass assembly.

In some embodiments, the apparatus may be further comprised of a main fluid inlet. In some embodiments, the main fluid inlet may be in communication with the fluid inlet of the first filter assembly. In some embodiments, the main fluid inlet may be in communication with the fluid inlet of the first filter assembly and the fluid inlet of the second filter assembly. In some embodiments, the main fluid inlet may be in communication with the fluid inlet of the first filter assembly, the fluid inlet of the second filter assembly, and the fluid inlet of the bypass assembly.

In some embodiments, the apparatus may be further comprised of a main fluid outlet. In some embodiments, the main fluid outlet may be in communication with the fluid outlet of the first filter assembly. In some embodiments, the main fluid outlet may be in communication with the fluid outlet of the first filter assembly and the fluid outlet of the second filter assembly. In some embodiments, the main fluid outlet may be in communication with the fluid outlet of the first filter assembly, the fluid outlet of the second filter assembly, and the fluid outlet of the bypass assembly.

In some embodiments, the apparatus may be further comprised of a main inlet manifold for providing the communication of the main fluid inlet with the fluid inlets of the first filter assembly, the second filter assembly and/or the bypass assembly.

In some embodiments, the apparatus may be further comprised of a main outlet manifold for providing the communication of the main fluid outlet with the fluid outlets of the first filter assembly, the second filter assembly and/or the bypass assembly.

In some embodiments, the bypass assembly may extend between the main inlet manifold and the main outlet manifold. In some embodiments, the inlet end of the bypass assembly may be comprised of the main inlet manifold. In some embodiments, the outlet end of the bypass assembly may be comprised of the main outlet manifold.

In some embodiments, the apparatus may be further comprised of a control system for selectively controlling a passage of the fluid through the first filter assembly, the second filter assembly, and/or the bypass assembly.

In some embodiments, the control system may be comprised of a plurality of valves.

In some embodiments, the control system may be comprised of a first filter assembly inlet valve. In some embodiments, the first filter assembly inlet valve may be located between the main inlet manifold and the first filter assembly inlet manifold.

In some embodiments, the control system may be comprised of a first filter assembly outlet valve. In some embodiments, the first filter assembly outlet valve may be located between the main outlet manifold and the first filter assembly outlet manifold.

In some embodiments, the control system may be comprised of a second filter assembly inlet valve. In some embodiments, the second filter assembly inlet valve may be located between the main inlet manifold and the second filter assembly inlet manifold.

In some embodiments, the control system may be comprised of a second filter assembly outlet valve. In some embodiments, the second filter assembly outlet valve may be located between the main outlet manifold and the second filter assembly outlet manifold.

In some embodiments, the control system may be comprised of a bypass assembly valve. In some embodiments, the bypass assembly valve may be located between the main inlet manifold and the main outlet manifold.

In some embodiments, the first filter assembly may be comprised of one or more bleed off ports for bleeding fluid from the first filter assembly. In some embodiments, the first filter assembly inlet manifold and/or the first filter assembly outlet manifold may be comprised of a bleed off port.

In some embodiments, the second filter assembly may be comprised of one or more bleed off ports for bleeding fluid from the second filter assembly. In some embodiments, the second filter assembly inlet manifold and/or the second filter assembly outlet manifold may be comprised of a bleed off port.

In some embodiments, the first filter assembly inlet manifold and/or the first filter assembly outlet manifold may be comprised of a servicing bore which is configured for removing the inner conduit of the first filter assembly from within the outer conduit of the first filter assembly. In some embodiments, the first filter assembly inlet manifold and/or the first filter assembly outlet manifold may be comprised of a servicing bore cap for sealing the servicing bore. In some embodiments, one or both of the servicing bore caps may be comprised of the bleed off port.

In some embodiments, the second filter assembly inlet manifold and/or the second filter assembly outlet manifold may be comprised of a servicing bore which is configured for removing the inner conduit of the second filter assembly from within the outer conduit of the second filter assembly. In some embodiments, the second filter assembly inlet manifold and/or the second filter assembly outlet manifold may be comprised of a servicing bore cap for sealing the servicing bore. In some embodiments, one or both of the servicing bore caps may be comprised of the bleed off port.

In some embodiments, the apparatus may be further comprised of a fluid containment skid. In some embodiments, the first filter assembly, the second filter assembly, and/or the bypass assembly may be mounted on the fluid containment skid. In some embodiments, the first filter assembly, the second filter assembly, the bypass assembly, the main inlet manifold, and the main outlet manifold may be mounted on the fluid containment skid.

The apparatus may be configured so that the filter assembly or filter assemblies are oriented at any desired orientation. In some embodiments, the apparatus may be configured so that the filter assembly or filter assemblies are oriented at a substantially horizontal orientation. One advantage of orienting the filter assemblies at a substantially horizontal orientation is that the apparatus can maintain a lower and more stable profile. A second advantage of orienting the filter assemblies at a substantially horizontal orientation is that the apparatus may be relatively more easy to clean, service and/or repair because the components of the apparatus are located relatively close to the surface upon which the apparatus is resting. A third advantage of orienting the filter assemblies at a substantially horizontal orientation is that the fluid may be passed through the apparatus in a generally horizontal direction, which may coincide with the direction which the fluid is moving at the main fluid inlet. As a result, wear of components of the apparatus due to the forces required to change the direction of the fluid before the fluid is passed through the filter assemblies may possibly be reduced.

In a first exemplary method aspect, the invention is a method of filtering debris from a fluid, the method comprising:
(a) providing a first filter assembly, wherein the first filter assembly comprises:
   (i) an outer conduit having an outer conduit sidewall and an inner surface defined by the outer conduit sidewall;
   (ii) an inner conduit having an inner conduit sidewall and an outer surface defined by the inner conduit sidewall, wherein the inner conduit is received within the outer conduit so that an inner conduit flowpath is defined within the inner conduit and an outer conduit flowpath is defined between the outer surface of the inner conduit sidewall and the inner surface of the outer conduit sidewall, and wherein the inner conduit sidewall is comprised of a filter which permits the fluid to pass between the inner conduit flowpath and the outer conduit flowpath;
   (iii) a fluid inlet in communication with the inner conduit flowpath; and
   (iv) a fluid outlet in communication with the outer conduit flowpath;
(b) passing the fluid through the first filter assembly;
(c) ceasing passing the fluid through the first filter assembly;
(d) removing the inner conduit of the first filter assembly from within the outer conduit of the first filter assembly;
(e) removing the debris from within the inner conduit of the first filter assembly; and
(f) replacing the inner conduit of the first filter assembly within the outer conduit of the first filter assembly.

In some embodiments, the method may be further comprised of:
(g) providing a second filter assembly, wherein the second filter assembly comprises:
   (i) an outer conduit having an outer conduit sidewall and an inner surface defined by the outer conduit sidewall;
   (ii) an inner conduit having an inner conduit sidewall and an outer surface defined by the inner conduit sidewall, wherein the inner conduit is received within the outer conduit so that an inner conduit flowpath is defined within the inner conduit and an outer conduit flowpath is defined between the outer surface of the inner conduit sidewall and the inner surface of the outer conduit sidewall, and wherein the inner conduit sidewall is comprised of a filter which permits the fluid to pass between the inner conduit flowpath and the outer conduit flowpath;
   (iii) a fluid inlet in communication with the inner conduit flowpath; and
   (iv) a fluid outlet in communication with the outer conduit flowpath;
(h) providing a control system for selectively controlling a passage of the fluid through the first filter assembly and the second filter assembly;
(i) actuating the control system to pass the fluid only through the second filter assembly;
(j) passing the fluid through the second filter assembly;
(k) actuating the control system to pass the fluid only through the first filter assembly;
(l) removing the inner conduit of the second filter assembly from within the outer conduit of the second filter assembly;
(m) removing the debris from within the inner conduit of the second filter assembly; and
(n) replacing the inner conduit of the second filter assembly within the outer conduit of the second filter assembly.

In some embodiments, the method may be further comprised of:
(o) providing a bypass assembly, wherein the bypass assembly comprises:
   (i) a bypass conduit defining a bypass flowpath;
   (ii) a fluid inlet in communication with the bypass flowpath; and
   (iii) a fluid outlet in communication with the bypass flowpath;
(p) actuating the control system to pass the fluid only through the bypass assembly; and
(q) passing the fluid through the bypass assembly.

### BRIEF DESCRIPTION OF DRAWINGS

Embodiments of the invention will now be described with reference to the accompanying drawings, in which:

FIG. 1 is a partial cutaway plan view of an exemplary embodiment of a debris filtering apparatus according to the invention.

FIG. 2 is an end view of the exemplary embodiment of the debris filtering apparatus depicted in FIG. 1.

FIG. 3 is a side view of the exemplary embodiment of the debris filtering apparatus depicted in FIG. 1.

FIG. 4 is a pictorial view of the exemplary embodiment of the debris filtering apparatus depicted in FIG. 1.

FIG. 5 is a partial cutaway pictorial view of a first filter assembly of the exemplary embodiment of the debris filtering apparatus depicted in FIG. 1.

FIG. 6 is a longitudinal section assembly drawing of the first filter assembly depicted in FIG. 5.

FIG. 7 is a pictorial view of an inner conduit of a filter assembly of the exemplary embodiment of the debris filtering apparatus depicted in FIG. 1.

FIG. 8 is an end view of the inner conduit depicted in FIG. 7.

FIG. 9 is a longitudinal section drawing of the inner conduit depicted in FIG. 7, taken along line 9-9 of FIG. 8.

FIG. 10 is a pictorial view of an end cap for the inner conduit depicted in FIG. 7.

FIG. 11 is an end view of the end cap depicted in FIG. 10.

FIG. 12 is a longitudinal section drawing of the end cap depicted in FIG. 10, taken along line 12-12 of FIG. 11.

FIG. 13 is a pictorial view of a locating ring for the inner conduit depicted in FIG. 7.

FIG. 14 is an end view of the locating ring depicted in FIG. 13.

FIG. 15 is a longitudinal section drawing of the locating ring depicted in FIG. 13, taken along line 15-15 of FIG. 14.

FIG. 16 is an end view of a servicing bore cap of a filter assembly of the exemplary embodiment of the debris filtering apparatus depicted in FIG. 1.

FIG. 17 is a longitudinal section drawing of the servicing bore cap depicted in FIG. 16, taken along line 17-17 of FIG. 16.

### DETAILED DESCRIPTION

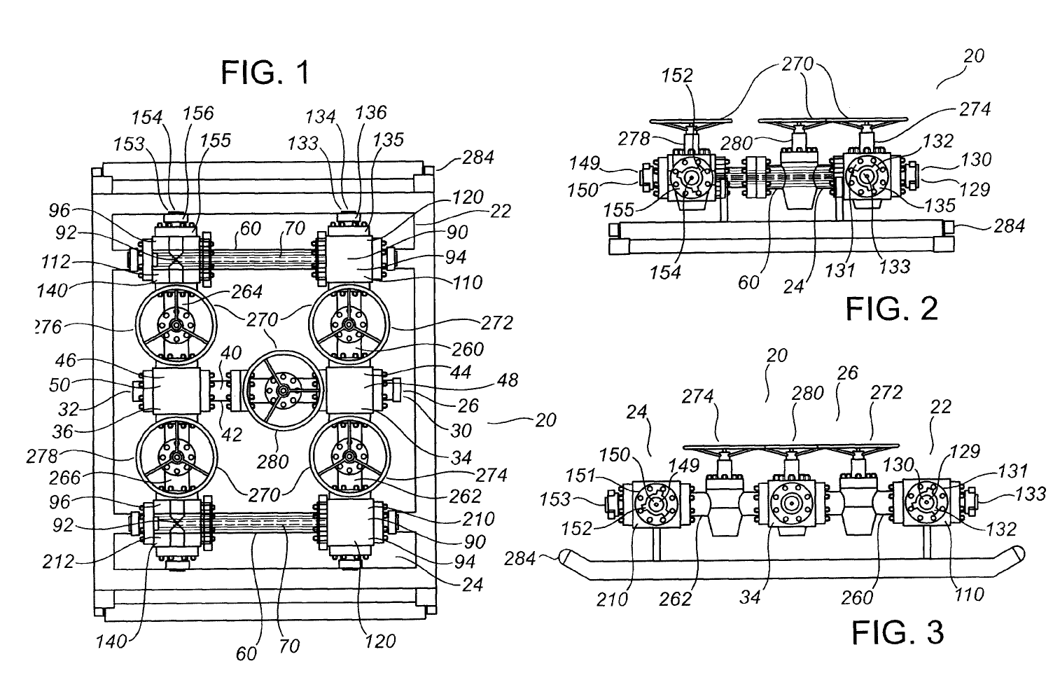

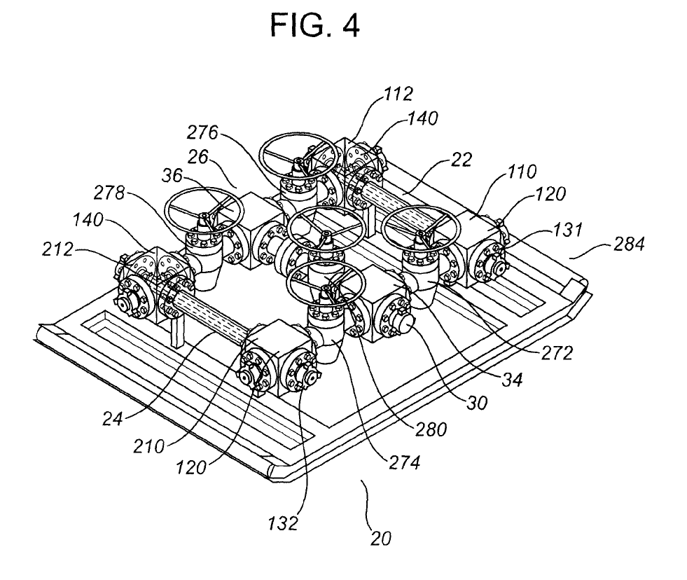

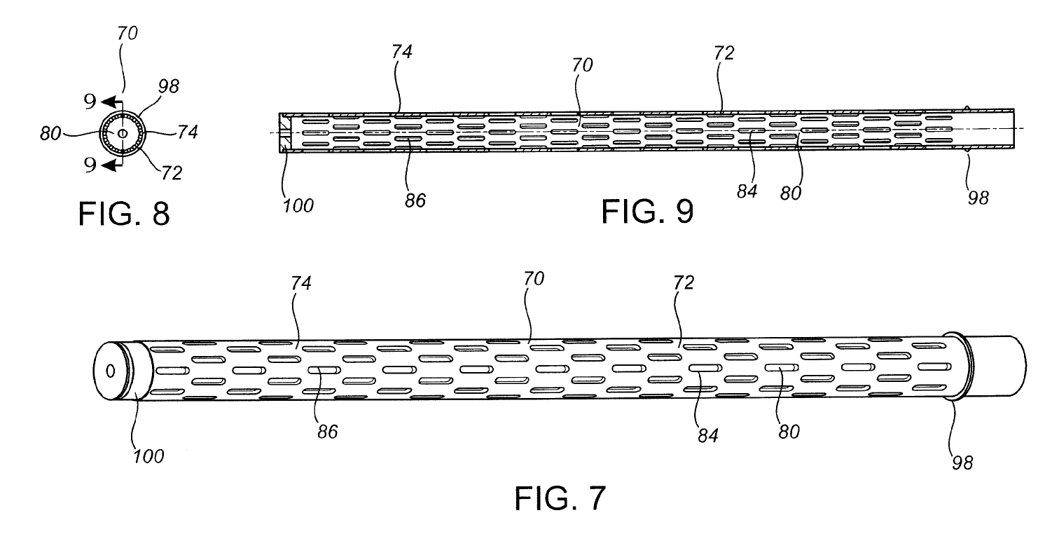

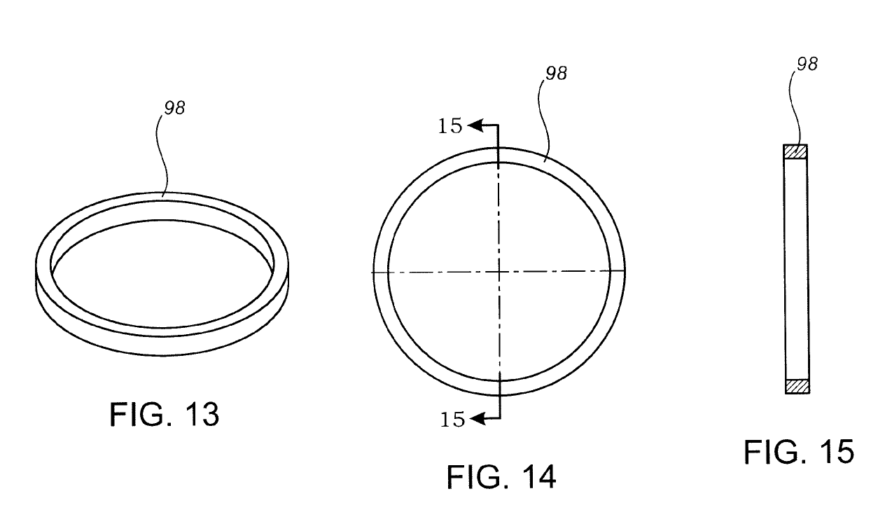

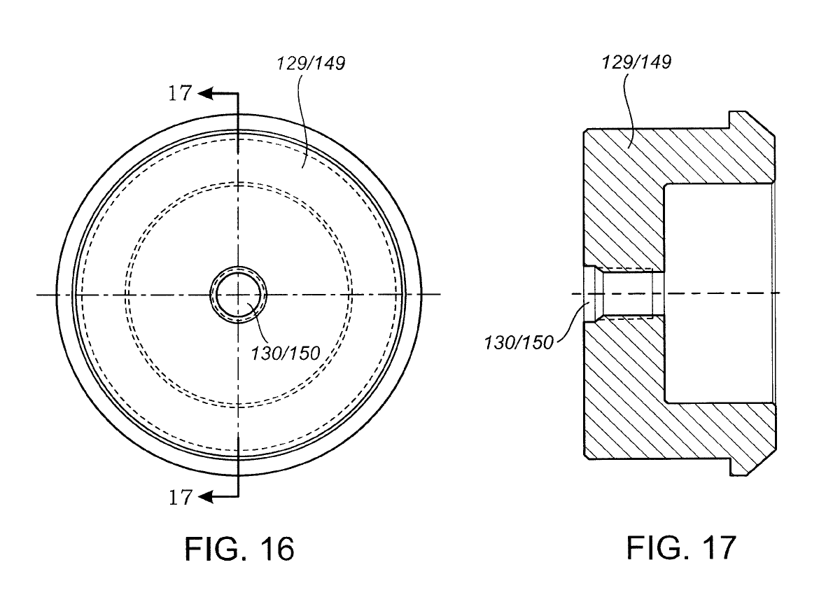

FIGS. 1-17 depict an exemplary embodiment of a debris filtering apparatus according to the invention.

Referring to FIGS. 1-4, the exemplary embodiment of the debris filtering apparatus (20) is comprised of a first filter assembly (22), a second filter assembly (24), and a bypass assembly (26). In other embodiments, the apparatus of the invention may be comprised of a single filter assembly, may be comprised of more than two filter assemblies, and may or may not be comprised of the bypass assembly (26).

The exemplary embodiment of the debris filtering apparatus (20) is further comprised of a main fluid inlet (30), a main fluid outlet (32), a main inlet manifold (34) and a main outlet manifold (36).

The bypass assembly (26) is comprised of a bypass conduit (40) which defines a bypass flowpath (42), a fluid inlet (44) which is in communication with the bypass flowpath (42), and a fluid outlet (46) which is in communication with the bypass flowpath (42).

The bypass assembly (26) has an inlet end (48) and an outlet end (50). The fluid inlet (44) of the bypass assembly (26) is associated with the inlet end (48) of the bypass assembly (26). The fluid outlet (46) of the bypass assembly (26) is associated with the outlet end (50) of the bypass assembly (26).

The inlet end (48) of the bypass assembly (26) is comprised of the main inlet manifold (34) and the outlet end (50) of the bypass assembly (26) is comprised of the main outlet manifold (36) so that the bypass assembly extends between the main inlet manifold (34) and the main outlet manifold (36).

Referring to FIGS. 1-17, the first filter assembly (22) is comprised of an outer conduit (60). The outer conduit (60) has an outer conduit sidewall (62) and an inner surface (64) defined by the outer conduit sidewall (62).

The first filter assembly (22) is further comprised of an inner conduit (70). The inner conduit (70) has an inner conduit sidewall (72) and an outer surface (74) defined by the inner conduit sidewall (72).

The inner conduit (70) is received within the outer conduit (60) so that an inner conduit flowpath (80) is defined within the inner conduit (70) and an outer conduit flowpath (82) is defined between the outer surface (74) of the inner conduit sidewall (72) and the inner surface (64) of the outer conduit sidewall (62).

The inner conduit sidewall (72) is comprised of a filter (84) which permits the fluid to pass between the inner conduit flowpath (80) and the outer conduit flowpath (82). The filter (84) is configured to retain an amount of debris within the inner conduit (70) as the fluid passes from the inner conduit flowpath (80) to the outer conduit flowpath (82).

In the exemplary embodiment, the filter (84) is comprised of slots (86) which are defined by the inner conduit sidewall (72). In other embodiments, the filter (84) may be comprised of any structure, device or apparatus which is suitable for filtering debris from the fluid. The filter (84) may be configured to facilitate use of the debris filtering apparatus (20) to achieve a suitable pressure drop and flowrate through the apparatus (20) and a suitable filtering capability to filter debris of various particle sizes.

The first filter assembly (22) is further comprised of a fluid inlet (90) which is in communication with the inner conduit flowpath (80) and a fluid outlet (92) which is in communication with the outer conduit flowpath (82).

The first filter assembly (22) has an inlet end (94) and an outlet end (96). The fluid inlet (90) of the first filter assembly (22) is associated with the inlet end (94) of the first filter assembly (22). The fluid outlet (92) of the first filter assembly (22) is associated with the outlet end (96) of the first filter assembly (22).

In the exemplary embodiment, the first filter assembly (22) is further comprised of a locating ring (98) and an end cap (100).

The locating ring (98) surrounds the outer surface (74) of the inner conduit (70) adjacent to the inlet end (94) and blocks the outer conduit flowpath (82) in order to prevent communication between the fluid inlet (90) and the outer conduit flowpath (82). The locating ring (98) also assists in positioning the inner conduit (70) at a desired longitudinal position relative to the outer conduit (60).

The end cap (100) covers the end of the inner conduit flowpath (80) adjacent to the outlet end (96) and blocks the inner conduit flowpath (80) in order to prevent communication between the fluid outlet (92).

The first filter assembly (22) is further comprised of a first filter assembly inlet manifold (110) and a first filter assembly outlet manifold (112). The first filter assembly inlet manifold (110) provides communication between the main fluid inlet (30) and the fluid inlet (90) of the first filter assembly (22). The first filter assembly outlet manifold (112) provides communication between the main fluid outlet (32) and the fluid outlet (92) of the first filter assembly (22).

In the exemplary embodiment, the first filter assembly inlet manifold (110) is comprised of a block (120) which defines four interconnecting bores. A first bore (122) is connected with the main fluid inlet (30). A second bore (124) receives the outer conduit (60) and the inner conduit (70). A third bore is a servicing bore (126) which is opposite to the second bore (124) and is configured to facilitate removing the inner conduit (70) from the outer conduit (60) therethrough for cleaning and/or servicing of the first filter assembly (22). A fourth bore (128) is redundant in order to provide versatility in configuring the block (120) and also provides additional capability for cleaning and servicing of the debris filtering apparatus (20) and the first filter assembly (22).

The first filter assembly inlet manifold (110) is further comprised of a servicing bore cap (129) for sealing the third bore (126). The servicing bore cap (129) is removable to facilitate removal of the inner conduit (70) from the outer conduit (60). The servicing bore cap (129) is comprised of a bleed off port (130) such as an NPT port for bleeding fluid from the first filter assembly (22).

In the exemplary embodiment, the servicing bore cap (129) is attached to the block (120) with the combination of a servicing bore flange (131) and a hammer union nut (132). The servicing bore flange (131) is mounted on the block (120). The servicing bore flange (131) is provided with external threads on its exterior surface and functions as a female sub for the hammer union nut (132). The servicing bore cap (129) is provided with a shoulder on its exterior surface and functions as a male sub for the hammer union nut (132). The hammer union nut (132) is provided with internal threads at one end, an internally projecting lug at the other end, and flanges spaced about its external surface for engagement with a wrench, hammer or other tool.

In order to attach the servicing bore cap (129) to the block (120), the hammer union nut (132) is placed over the servicing bore cap (129) so that the internally projecting lug on the hammer union nut (132) engages with the shoulder on the servicing bore cap (129) and the hammer union nut (132) is then threaded onto the servicing bore flange (131) in order to clamp the servicing bore cap (129) between the servicing bore flange (131) and the lug on the hammer union nut (132). A seal between the servicing bore cap (129) and the servicing bore flange (131) may be provided by metal-to-metal contact between the servicing bore cap (129) and the servicing bore flange (131) and/or by a sealing device such as an O-ring (not shown) interposed between the servicing bore cap (129) and the servicing bore flange (131).

The servicing bore cap (129) may be removed by engaging the flanges on the hammer union nut (132) with a wrench, hammer and turning the hammer union nut (132) relative to the servicing bore flange (131) in order to break the connection between the hammer union nut (132) and the servicing bore flange (131). An advantage of using a hammer union connection for the servicing bore cap (129) is that the servicing bore cap (129) is not directly connected with the servicing bore flange (131), so that the likelihood of the servicing bore cap (129) becoming stuck on the servicing bore flange (131) is reduced.

In the exemplary embodiment, the first filter assembly inlet manifold (110) is further comprised of a fourth bore cap (133) for sealing the fourth bore (128). The fourth bore cap (133) is comprised of a bleed off port (134) such as an NPT port for bleeding fluid from the first filter assembly (22).

In the exemplary embodiment, the fourth bore cap (133) is identical to the servicing bore cap (129), and is similarly attached to the block (120) with the combination of a fourth bore flange (135) and a hammer union nut (136).

In the exemplary embodiment, the first filter assembly outlet manifold (112) is comprised of a block (140) which defines four interconnecting bores. A first bore (142) is connected with the main fluid outlet (32). A second bore (144) receives the outer conduit (60) and the inner conduit (70). A third bore is a servicing bore (146) which is opposite to the second bore (144) and is configured to facilitate removing the inner conduit (70) from the outer conduit (60) therethrough for cleaning and/or servicing of the first filter assembly (22). A fourth bore (148) is redundant in order to provide versatility in configuring the block (140) and also provides additional capability for cleaning and servicing of the debris filtering apparatus (20) and the first filter assembly (22).

The first filter assembly outlet manifold (112) is further comprised of a servicing bore cap (149) for sealing the third bore (146). The servicing bore cap (149) is removable to facilitate removal of the inner conduit (70) from the outer conduit (60). The servicing bore cap (149) is comprised of a bleed off port (150) such as an NPT port for bleeding fluid from the first filter assembly (22).

In the exemplary embodiment, the servicing bore cap (149) is attached to the block (140) with the combination of a servicing bore flange (151) and a hammer union nut (152). The servicing bore flange (151) is mounted on the block (140). The servicing bore flange (151) is provided with external threads on its exterior surface and functions as a female sub for the hammer union nut (152). The servicing bore cap (149) is provided with a shoulder on its exterior surface and functions as a male sub for the hammer union nut (152). The hammer union nut (152) is provided with internal threads at one end, an internally projecting lug at the other end, and flanges spaced about its external surface for engagement with a wrench, hammer or other tool.

In order to attach the servicing bore cap (149) to the block (140), the hammer union nut (152) is placed over the servicing bore cap (149) so that the internally projecting lug on the hammer union nut (152) engages with the shoulder on the servicing bore cap (149) and the hammer union nut (152) is then threaded onto the servicing bore flange (151) in order to clamp the servicing bore cap (149) between the servicing bore flange (151) and the lug on the hammer union nut (152). A seal between the servicing bore cap (149) and the servicing bore flange (151) may be provided by metal-to-metal contact between the servicing bore cap (149) and the servicing bore flange (151) and/or by a sealing device such as an O-ring (not shown) interposed between the servicing bore cap (149) and the servicing bore flange (151).

The servicing bore cap (149) may be removed by engaging the flanges on the hammer union nut (152) with a wrench, hammer and turning the hammer union nut (152) relative to the servicing bore flange (151) in order to break the connection between the hammer union nut (152) and the servicing bore flange (151). An advantage of using a hammer union connection for the servicing bore cap (149) is that the servicing bore cap (149) is not directly connected with the servicing bore flange (151), so that the likelihood of the servicing bore cap (149) becoming stuck on the servicing bore flange (151) is reduced.

In the exemplary embodiment, the first filter assembly outlet manifold (112) is further comprised of a fourth bore cap (153) for sealing the fourth bore (148). The fourth bore cap (153) is comprised of a bleed off port (154) such as an NPT port for bleeding fluid from the first filter assembly (22).

In the exemplary embodiment, the fourth bore cap (153) is identical to the servicing bore cap (149), and is similarly attached to the block (140) with the combination of a fourth bore flange (155) and a hammer union nut (156).

In the exemplary embodiment, the second filter assembly (24) is substantially identical to the first filter assembly (22). As a result, in the description of the second filter assembly (24) which follows, features which are equivalent in the first filter assembly (22) and the second filter assembly (24) are assigned the same reference numbers, and features of the second filter assembly (24) which are similar, but not necessarily identical to features of the first filter assembly (22) are assigned reference numbers which are higher by 100 than the reference number which is assigned to the corresponding feature in the first filter assembly (22).

Referring to FIGS. 1-17, the second filter assembly (24) is comprised of an outer conduit (60). The outer conduit (60) has an outer conduit sidewall (62) and an inner surface (64) defined by the outer conduit sidewall (62).

The second filter assembly (24) is further comprised of an inner conduit (70). The inner conduit (70) has an inner conduit sidewall (72) and an outer surface (74) defined by the inner conduit sidewall (72).

The inner conduit (70) is received within the outer conduit (60) so that an inner conduit flowpath (80) is defined within the inner conduit (70) and an outer conduit flowpath (82) is defined between the outer surface (74) of the inner conduit sidewall (72) and the inner surface (64) of the outer conduit sidewall (62).

The inner conduit sidewall (72) is comprised of a filter (84) which permits the fluid to pass between the inner conduit flowpath (80) and the outer conduit flowpath (82). The filter (84) is configured to retain an amount of debris within the inner conduit (70) as the fluid passes from the inner conduit flowpath (80) to the outer conduit flowpath (82).

In the exemplary embodiment, the filter (84) is comprised of slots (86) which are defined by the inner conduit sidewall (72). In other embodiments, the filter (84) may be comprised of any structure, device or apparatus which is suitable for filtering debris from the fluid. The filter (84) may be configured to facilitate use of the debris filtering apparatus (20) to achieve a suitable pressure drop and flowrate through the apparatus (20) and a suitable filtering capability to filter debris of various particle sizes.

The second filter assembly (24) is further comprised of a fluid inlet (90) which is in communication with the inner conduit flowpath (80) and a fluid outlet (92) which is in communication with the outer conduit flowpath (82).

The second filter assembly (24) has an inlet end (94) and an outlet end (96). The fluid inlet (90) of the second filter assembly (24) is associated with the inlet end (94) of the second filter assembly (24). The fluid outlet (92) of the second filter assembly (24) is associated with the outlet end (96) of the second filter assembly (24).

In the exemplary embodiment, the second filter assembly (24) is further comprised of a locating ring (98) and an end cap (100).

The locating ring (98) surrounds the outer surface (74) of the inner conduit (70) adjacent to the inlet end (94) and blocks the outer conduit flowpath (82) in order to prevent communication between the fluid inlet (90) and the outer conduit flowpath (82). The locating ring (98) also assists in positioning the inner conduit (70) at a desired longitudinal position relative to the outer conduit (60).

The end cap (100) covers the end of the inner conduit flowpath (80) adjacent to the outlet end (96) and blocks the inner conduit flowpath (80) in order to prevent communication between the fluid outlet (92).

The second filter assembly (24) is further comprised of a second filter assembly inlet manifold (210) and a second filter assembly outlet manifold (212). The second filter assembly inlet manifold (210) provides communication between the main fluid inlet (30) and the fluid inlet (90) of the second filter assembly (24). The second filter assembly outlet manifold (212) provides communication between the main fluid outlet (32) and the fluid outlet (92) of the second filter assembly (24).

In the exemplary embodiment, the second filter assembly inlet manifold (210) is comprised of a block (120) which defines four interconnecting bores. A first bore (122) is connected with the main fluid inlet (30). A second bore (124) receives the outer conduit (60) and the inner conduit (70). A third bore is a servicing bore (126) which is opposite to the second bore (124) and is configured to facilitate removing the inner conduit (70) from the outer conduit (60) therethrough for cleaning and/or servicing of the second filter assembly (24). A fourth bore (128) is redundant in order to provide versatility in configuring the block (120) and also provides additional capability for cleaning and servicing of the debris filtering apparatus (20) and the second filter assembly (24).

The second filter assembly inlet manifold (210) is further comprised of a servicing bore cap (129) for sealing the third bore (126). The servicing bore cap (129) is removable to facilitate removal of the inner conduit (70) from the outer conduit (60). The servicing bore cap (129) is comprised of a bleed off port (130) such as an NPT port for bleeding fluid from the second filter assembly (24).

In the exemplary embodiment, the servicing bore cap (129) is attached to the block (120) with the combination of a servicing bore flange (131) and a hammer union nut (132). The servicing bore flange (131) is mounted on the block (120). The servicing bore flange (131) is provided with external threads on its exterior surface and functions as a female sub for the hammer union nut (132). The servicing bore cap (129) is provided with a shoulder on its exterior surface and functions as a male sub for the hammer union nut (132). The hammer union nut (132) is provided with internal threads at one end, an internally projecting lug at the other end, and flanges spaced about its external surface for engagement with a wrench, hammer or other tool.

In order to attach the servicing bore cap (129) to the block (120), the hammer union nut (132) is placed over the servicing bore cap (129) so that the internally projecting lug on the hammer union nut (132) engages with the shoulder on the servicing bore cap (129) and the hammer union nut (132) is then threaded onto the servicing bore flange (131) in order to clamp the servicing bore cap (129) between the servicing bore flange (131) and the lug on the hammer union nut (132). A seal between the servicing bore cap (129) and the servicing bore flange (131) may be provided by metal-to-metal contact between the servicing bore cap (129) and the servicing bore flange (131) and/or by a sealing device such as an O-ring (not shown) interposed between the servicing bore cap (129) and the servicing bore flange (131).

The servicing bore cap (129) may be removed by engaging the flanges on the hammer union nut (132) with a wrench, hammer and turning the hammer union nut (132) relative to the servicing bore flange (131) in order to break the connection between the hammer union nut (132) and the servicing bore flange (131). An advantage of using a hammer union connection for the servicing bore cap (129) is that the servicing bore cap (129) is not directly connected with the servicing bore flange (131), so that the likelihood of the servicing bore cap (129) becoming stuck on the servicing bore flange (131) is reduced.

In the exemplary embodiment, the second filter assembly inlet manifold (210) is further comprised of a fourth bore cap (133) for sealing the fourth bore (128). The fourth bore cap (133) is comprised of a bleed off port (134) such as an NPT port for bleeding fluid from the second filter assembly (24).

In the exemplary embodiment, the fourth bore cap (133) is identical to the servicing bore cap (129), and is similarly attached to the block (120) with the combination of a fourth bore flange (135) and a hammer union nut (136).

In the exemplary embodiment, the second filter assembly outlet manifold (212) is comprised of a block (140) which defines four interconnecting bores. A first bore (142) is connected with the main fluid outlet (32). A second bore (144) receives the outer conduit (60) and the inner conduit (70). A third bore is a servicing bore (146) which is opposite to the second bore (144) and is configured to facilitate removing the inner conduit (70) from the outer conduit (60) therethrough for cleaning and/or servicing of the second filter assembly (24). A fourth bore (148) is redundant in order to provide versatility in configuring the block (140) and also provides additional capability for cleaning and servicing of the debris filtering apparatus (20) and the second filter assembly (24).

The second filter assembly outlet manifold (212) is further comprised of a servicing bore cap (149) for sealing the third bore (146). The servicing bore cap (149) is removable to facilitate removal of the inner conduit (70) from the outer conduit (60). The servicing bore cap (149) is comprised of a bleed off port (150) such as an NPT port for bleeding fluid from the second filter assembly (24).

In the exemplary embodiment, the servicing bore cap (149) is attached to the block (140) with the combination of a servicing bore flange (151) and a hammer union nut (152). The servicing bore flange (151) is mounted on the block (140). The servicing bore flange (151) is provided with external threads on its exterior surface and functions as a female sub for the hammer union nut (152). The servicing bore cap (149) is provided with a shoulder on its exterior surface and functions as a male sub for the hammer union nut (152). The hammer union nut (152) is provided with internal threads at one end, an internally projecting lug at the other end, and flanges spaced about its external surface for engagement with a wrench, hammer or other tool.

In order to attach the servicing bore cap (149) to the block (140), the hammer union nut (152) is placed over the servicing bore cap (149) so that the internally projecting lug on the hammer union nut (152) engages with the shoulder on the servicing bore cap (149) and the hammer union nut (152) is then threaded onto the servicing bore flange (151) in order to clamp the servicing bore cap (149) between the servicing bore flange (151) and the lug on the hammer union nut (152). A seal between the servicing bore cap (149) and the servicing bore flange (151) may be provided by metal-to-metal contact between the servicing bore cap (149) and the servicing bore flange (151) and/or by a sealing device such as an O-ring (not shown) interposed between the servicing bore cap (149) and the servicing bore flange (151).

The servicing bore cap (149) may be removed by engaging the flanges on the hammer union nut (152) with a wrench, hammer and turning the hammer union nut (152) relative to the servicing bore flange (151) in order to break the connection between the hammer union nut (152) and the servicing bore flange (151). An advantage of using a hammer union connection for the servicing bore cap (149) is that the servicing bore cap (149) is not directly connected with the servicing bore flange (151), so that the likelihood of the servicing bore cap (149) becoming stuck on the servicing bore flange (151) is reduced.

In the exemplary embodiment, the second filter assembly outlet manifold (212) is further comprised of a fourth bore cap (153) for sealing the fourth bore (148). The fourth bore cap (153) is comprised of a bleed off port (154) such as an NPT port for bleeding fluid from the second filter assembly (24).

In the exemplary embodiment, the fourth bore cap (153) is identical to the servicing bore cap (149), and is similarly attached to the block (140) with the combination of a fourth bore flange (155) and a hammer union nut (156).

Referring to FIGS. 1-4, the exemplary embodiment of the debris filtering apparatus (20) is further comprised of a first inlet conduit (260) which connects the main inlet manifold (34) with the first filter assembly inlet manifold (110), a second inlet conduit (262) which connects the main inlet manifold (34) with the second filter assembly inlet manifold (210), a first outlet conduit (264) which connects the main outlet manifold (36) with the first filter assembly outlet manifold (112), and a second outlet conduit (266) which connects the main outlet manifold (36) with the second filter assembly outlet manifold (212).

Referring to FIGS. 1-4, the exemplary embodiment of the debris filtering apparatus (20) is further comprised of a control system (270) for selectively controlling a passage of the fluid through the first filter assembly (22), the second filter assembly (24) and/or through the bypass assembly (26).

In the exemplary embodiment, the control system (270) is comprised of a first filter assembly inlet valve (272) positioned in the first inlet conduit (260), a second filter assembly inlet valve (274) positioned in the second inlet conduit (262), a first filter assembly outlet valve (276) positioned in the first outlet conduit (264), a second filter assembly outlet valve (278) positioned in the second outlet conduit (266), and a bypass assembly valve (280) positioned in the bypass conduit (40).

The exemplary embodiment of the debris filtering apparatus (20) is further comprised of a fluid containment skid (284). Some or all of the components of the debris filtering apparatus (20) may be mounted on the fluid containment skid (284). As depicted in FIGS. 1-4, all of the components of the debris filtering apparatus (20) are mounted on the fluid containment skid (284). As depicted in FIGS. 1-4, the first filter assembly (22) and the second filter assembly (24) are oriented at a substantially horizontal orientation on and relative to the fluid containment skid (284).

The debris filtering apparatus (20) of the exemplary embodiment therefore provides for three separate fluid paths between the main fluid inlet (30) and the main fluid outlet (32) which can be selected using the control system (270), thereby enabling the debris filtering apparatus (20) to be in continuous use without requiring down time for cleaning, servicing and/or repair of the debris filtering apparatus (20). In typical use of the debris filtering apparatus (20), fluid will be passed through either the first filter assembly (22) or the second filter assembly (24) so that one of the filter assemblies (22,24) is in operation while the other of the filter assemblies (22,24) is being cleaned, serviced and/or repaired. The bypass assembly (26) does not provide any filtering capability, so that fluid will not typically be passed through the bypass assembly (26) except in an emergency or in circumstances where filtering of the fluid is not required.

The debris filtering apparatus (20) may be assembled onto the fluid containment skid (284) at a remote location and may be delivered to a site for use as a single load and a single unit. During use of the debris filtering apparatus (20), it will typically be necessary to disassemble and reassemble the filter assemblies (22,24) periodically as the inner conduits (70) become filled with debris.

Assembly, use and disassembly of a filter assembly (22,24) is described as follows with reference to the first filter assembly (22).

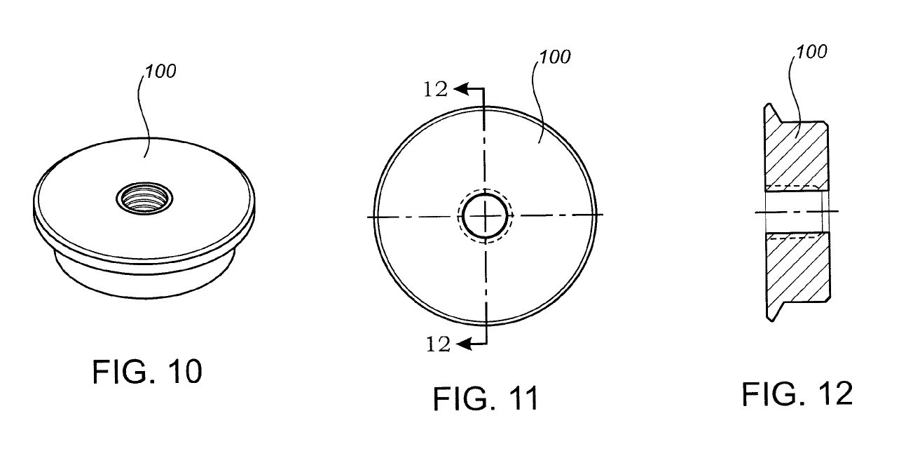

Referring to FIGS. 9-10, the inner conduit (70) is prepared for insertion within the outer conduit (60) by mounting the locating ring (98) on the outer surface (74) of the inner conduit sidewall (72) adjacent to one end of the inner conduit (70) by press fitting, crimping, welding or by some other suitable means and by fastening the end cap (100) within the opposite end of the inner conduit (70). Preferably, the end cap (100) is removably fastened within the inner conduit (70) so that the end cap (100) can be removed for cleaning and/or servicing of the first filter assembly (22).

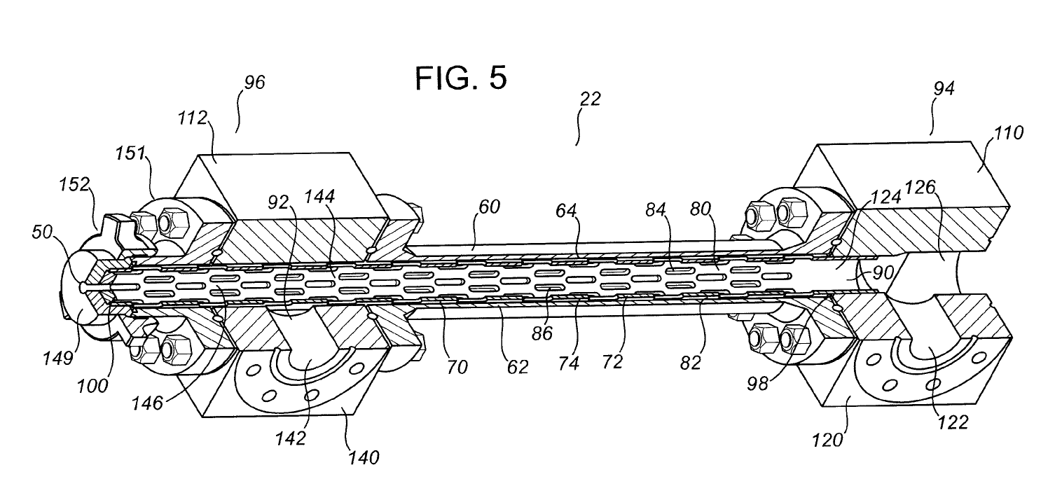

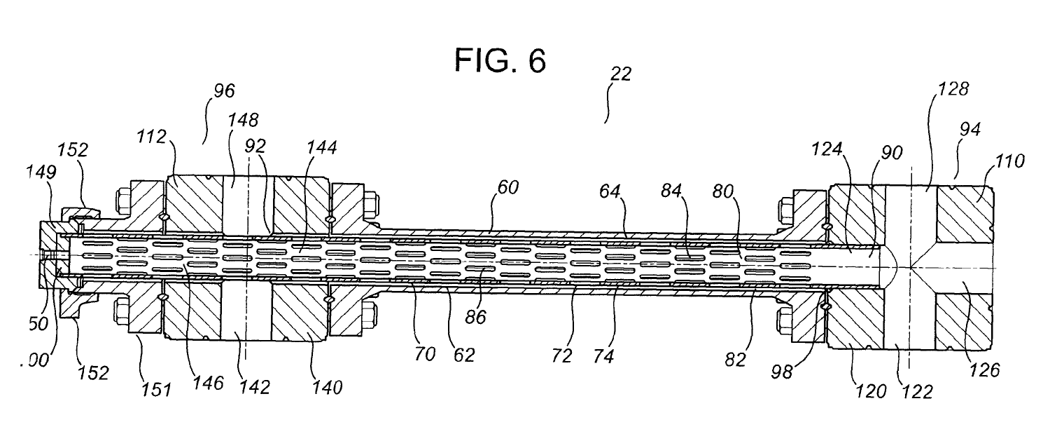

In order to assemble the first filter assembly (22) and with reference to FIGS. 5-6, the inner conduit (70) may be inserted within the outer conduit (60) from either the inlet end (94) or the outlet end (96) of the first filter assembly (22) by removing the appropriate servicing bore cap (130,150) from the appropriate block (120,140) and passing the inner conduit (70) through the appropriate servicing bore (126,146).

Preferably, however, the inner conduit (70) is inserted within the outer conduit (60) from the outlet end (96) of the first filter assembly (22) so that the inner conduit (70) is inserted “against the flow” through the first filter assembly (22), which assists in facilitating easy removal of the inner conduit (70) from the outer conduit (60) when cleaning and/or servicing of the first filter assembly (22) is required. As a result, preferably the servicing bore cap (149) is removed from the block (140) and the inner conduit (70) is passed through the servicing bore (146).

The inner conduit (70) is passed through the outer conduit (60) until the locating ring (98) abuts the block (120) of the first filter assembly inlet manifold (110), thus “locating” the inner conduit (70) at the appropriate longitudinal position relative to the inner conduit (60). The servicing bore cap (149) is then replaced to seal the servicing bore (146).

The first filter assembly (22) is then assembled and ready for use.

Referring to FIGS. 1-6, in order to use the first filter assembly (22) the control system (270) must be actuated so that the fluid passes only through the first filter assembly (22) between the main fluid inlet (30) and the main fluid outlet (32). The control system (270) is so actuated by closing the second filter assembly inlet valve (274), the second filter assembly outlet valve (278) and the bypass assembly valve (280) and by opening the first filter assembly inlet valve (272) and the first filter assembly outlet valve (276).

The fluid may then pass from the main fluid inlet (30), through the main inlet manifold (34), through the first inlet conduit (260), through the first filter assembly inlet manifold (110), through the inner conduit (70), through the outer conduit (60), through the first filter assembly outlet manifold (112), through the first outlet conduit (264), through the main outlet manifold (36) to the main fluid outlet (32).

Referring to FIGS. 5-6, the first filter assembly inlet manifold (110) is configured so that the inner conduit (70) fits snugly within the second bore (124) at the inlet end (94) of the first filter assembly (22) so that the fluid passes from the first filter assembly inlet manifold (110) into the inner conduit (70). The locating ring (98) assists in minimizing the passage of fluid from the first filter assembly inlet manifold (110) into the outer conduit (60) by effectively blocking the outer conduit flowpath (82) at the first filter assembly inlet manifold (110).

The fluid passes through the inner conduit (70) along the length of the inner conduit (70) but is prevented from passing from the inner conduit (70) into the first filter assembly outlet manifold (112) by the end cap (100), which effectively blocks the inner conduit flowpath at the first filter assembly outlet manifold (112). As the fluid passes through the inner conduit flowpath (80) along the length of the inner conduit (70) the fluid passes through the slots (84) in the inner conduit (70) to the outer conduit flowpath (82), while debris is retained within the inner conduit (70).

The first filter assembly outlet manifold (112) is configured so that inner conduit does not fit snugly within the second bore (144) at the outlet end (96) of the first filter assembly (22), thereby providing a continuation of the outer conduit flowpath (82) into the first filter assembly outlet manifold (112). The filtered fluid may therefore pass from the outer conduit flowpath (82) into the first filter assembly outlet manifold (112) at the outlet end of the first filter assembly (96).

Any fluid which may leak from the debris filtering apparatus (20) during use of the first filter assembly (22) will be contained on the fluid containment skid (284).

Referring again to FIGS. 5-6, it is noted that the inner conduit (70) extends within each of the first filter assembly inlet manifold (110) and the first filter assembly outlet manifold (112) such that no significant wash points are provided at either the inlet end (94) or the outlet end (96) of the first filter assembly (22). In addition, the configuration of the inner conduit (70) within the first filter assembly inlet manifold (110 and the first filter assembly outlet manifold (112) provides an inner diameter (ID) equal to the size of the inner conduit (70) from the inlet end (94) to the outlet end (96) of the first filter assembly (22).

Use of the first filter assembly (22) may be interrupted as necessary to facilitate cleaning, servicing and/or repair of the first filter assembly (22). An increase in pressure drop through the first filter assembly (22) may indicate that the first filter assembly (22) requires cleaning and/or servicing. Pressure sensors (not shown) may be incorporated into the debris filtering apparatus (20) to assist in monitoring the operation of the filter assemblies (22,24).

Use of the first filter assembly (22) may be interrupted by actuating the control system (270) to cease passing the fluid through the first filter assembly (22) and thus isolate the first filter assembly (22).

The control system (270) is so actuated by closing the first filter assembly inlet valve (272) and the first filter assembly outlet valve (276). If use of the debris filtering apparatus (20) is to continue during the interruption of the use of the first filter assembly (22), the control system (270) is also actuated to pass fluid through either the second filter assembly (24) or the bypass assembly (26). The control system (270) is actuated to pass fluid through the second filter assembly (24) by opening the second filter assembly inlet valve (274) and the second filter assembly outlet valve (278). The control system (270) is actuated to pass fluid through the bypass assembly (26) by opening the bypass assembly valve (280).

Once the first filter assembly (22) has been isolated by closing the first filter assembly inlet valve (272) and the first filter assembly outlet valve (276), fluid and pressure may be released from the first filter assembly (22) by opening one or more of the bleed off ports (130,134,150,154).

Once fluid and pressure have been released from the first filter assembly (22), the first filter assembly may be disassembled for cleaning, servicing and/or repair by removing the servicing bore cap (149) and removing the inner conduit (70) from the outer conduit (60) by pulling the inner conduit (70) through the servicing bore (146).

The servicing bore cap (149) is removed from the block (140) by engaging the flanges on the external surface of the hammer union nut (152) with a wrench, hammer or other tool and turning the hammer union nut (152) to break the threaded connection between the hammer union nut (152) and the servicing bore flange (151). The servicing bore cap (149) may then be removed from the hammer union nut (152) to expose the inner conduit (70).

Referring to FIG. 6, in the exemplary embodiment, the first filter assembly (22) is configured so that when the servicing bore cap (149) is removed, a length of the inner conduit (70) protrudes from the servicing bore flange (151). This protruding length of the inner conduit (70) facilitates grasping the protruding end of the inner conduit (70) with a tool (not shown) as may be required in order to rotate and/or loosen the inner conduit (70) while it is contained within the outer conduit (60).

Once the inner conduit (70) is removed from the outer conduit (60), the inner conduit (70) may be cleaned to remove debris from within the inner conduit (70) and/or from the filter (84). The debris may be collected for analysis and/or may be disposed of.

The inner conduit (70) may then be replaced within the outer conduit (60) and the servicing bore (146) may be resealed with the servicing bore cap (149) so that the first filter assembly (22) is again ready for use.

Meanwhile, use of the second filter assembly (24) may be interrupted as necessary to facilitate cleaning, servicing and/or repair of the second filter assembly (24), in a similar manner as described above with respect to the first filter assembly (22).

More particularly, use of the second filter assembly (24) may be interrupted by actuating the control system (270) to cease passing the fluid through the second filter assembly (244) and thus isolate the second filter assembly (24).

The control system (270) is so actuated by closing the second filter assembly inlet valve (274) and the second filter assembly outlet valve (278). If use of the debris filtering apparatus (20) is to continue during the interruption of the use of the second filter assembly (24), the control system (270) is also actuated to pass fluid through either the first filter assembly (22) or the bypass assembly (26). The control system (270) is actuated to pass fluid through the first filter assembly (22) by opening the first filter assembly inlet valve (272) and the first filter assembly outlet valve (276). The control system (270) is actuated to pass fluid through the bypass assembly (26) by opening the bypass assembly valve (280).

In this document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The embodiments of the invention in which an exclusive property or privilege is claimed are defined as follows:

1. An apparatus for filtering debris from a fluid, the apparatus comprising:
(a) a first filter assembly, wherein the first filter assembly comprises:
(i) an outer conduit having an outer conduit sidewall and an inner surface defined by the outer conduit sidewall;
(ii) an inner conduit having an inner conduit sidewall and an outer surface defined by the inner conduit sidewall, wherein the inner conduit is received within the outer conduit so that an inner conduit flowpath is defined within the inner conduit and an outer conduit flowpath is defined between the outer surface of the inner conduit sidewall and the inner surface of the outer conduit sidewall, and wherein the inner conduit sidewall is comprised of a filter which permits the fluid to pass between the inner conduit flowpath and the outer conduit flowpath;
(iii) a fluid inlet in communication with the inner conduit flowpath; and
(iv) a fluid outlet in communication with the outer conduit flowpath.

2. The apparatus as claimed in claim 1 wherein the outer conduit flowpath of the first filter assembly is blocked in order to prevent communication between the fluid inlet and the outer conduit flowpath and wherein the inner conduit flowpath of the first filter assembly is blocked in order to prevent communication between the fluid outlet and the inner conduit flowpath.

3. The apparatus as claimed in claim 2 wherein the filter of the first filter assembly is configured to retain an amount of the debris within the inner conduit as the fluid passes from the inner conduit flowpath to the outer conduit flowpath.

4. The apparatus as claimed in claim 3 wherein the first filter assembly has an inlet end and an outlet end, wherein the fluid inlet is associated with the inlet end of the first filter assembly, and wherein the fluid outlet is associated with the outlet end of the first filter assembly.

5. The apparatus as claimed in claim 4 wherein the inlet end of the first filter assembly is comprised of a first filter assembly inlet manifold and wherein the outlet end of the first filter assembly is comprised of a first filter assembly outlet manifold.

6. The apparatus as claimed in claim 5 wherein the apparatus is further comprised of a second filter assembly, wherein the second filter assembly comprises:
(i) an outer conduit having an outer conduit sidewall and an inner surface defined by the outer conduit sidewall;
(ii) an inner conduit having an inner conduit sidewall and an outer surface defined by the inner conduit sidewall, wherein the inner conduit is received within the outer conduit so that an inner conduit flowpath is defined within the inner conduit and an outer conduit flowpath is defined between the outer surface of the inner conduit sidewall and the inner surface of the outer conduit sidewall, and wherein the inner conduit sidewall is comprised of a filter which permits the fluid to pass between the inner conduit flowpath and the outer conduit flowpath;
(iii) a fluid inlet in communication with the inner conduit flowpath; and
(iv) a fluid outlet in communication with the outer conduit flowpath.

7. The apparatus as claimed in claim 6 wherein the outer conduit flowpath of the second filter assembly is blocked in order to prevent communication between the fluid inlet and the outer conduit flowpath, wherein the inner conduit flowpath of the second filter assembly is blocked in order to prevent communication between the fluid outlet and the inner conduit flowpath.

8. The apparatus as claimed in claim 7 wherein the filter of the second filter assembly is configured to retain an amount of the debris within the inner conduit as the fluid passes from the inner conduit flowpath to the outer conduit flowpath.

9. The apparatus as claimed in claim 8 wherein the second filter assembly has an inlet end and an outlet end, wherein the fluid inlet is associated with the inlet end of the second filter assembly, and wherein the fluid outlet is associated with the outlet end of the second filter assembly.

10. The apparatus as claimed in claim 9 wherein the inlet end of the second filter assembly is comprised of a second filter assembly inlet manifold and wherein the outlet end of the second filter assembly is comprised of a second filter assembly outlet manifold.

11. The apparatus as claimed in claim 10, further comprising a bypass assembly, wherein the bypass assembly comprises:
(a) a bypass conduit defining a bypass flowpath;
(b) a fluid inlet in communication with the bypass flowpath; and
(c) a fluid outlet in communication with the bypass flowpath.

12. The apparatus as claimed in claim 11, further comprising a main fluid inlet in communication with the fluid inlets of each of the first filter assembly, the second filter assembly, and the bypass assembly, and further comprising a main fluid outlet in communication with the fluid outlets of each of the first filter assembly, the second filter assembly, and the bypass assembly.

13. The apparatus as claimed in claim 12, further comprising a main inlet manifold for providing the communication of the main fluid inlet with the fluid inlets of each of the first filter assembly, the second filter assembly, and the bypass assembly, and further comprising a main outlet manifold for providing the communication of the main fluid outlet with the fluid outlets of each of the first filter assembly, the second filter assembly, and the bypass assembly.

14. The apparatus as claimed in claim 13 further comprising a control system for selectively controlling a passage of the fluid through the first filter assembly, the second filter assembly and the bypass assembly.

15. The apparatus as claimed in claim 14 wherein the control system is comprised of a plurality of valves.

16. The apparatus as claimed in claim 15 wherein the first filter assembly inlet manifold, the first filter assembly outlet manifold, the second filter assembly inlet manifold, and the second filter assembly outlet manifold are each comprised of a bleed off port.

17. The apparatus as claimed in claim 15 wherein the first filter assembly outlet manifold is further comprised of a servicing bore, and wherein the first filter assembly outlet manifold and the inner conduit of the first filter assembly are configured so that the inner conduit may be removed from the outer conduit of the first filter assembly through the servicing bore.

18. The apparatus as claimed in claim 17 wherein the first filter assembly outlet manifold is further comprised of a servicing bore cap for sealing the servicing bore.

19. The apparatus as claimed in claim 15 wherein the second filter assembly outlet manifold is further comprised of a servicing bore, and wherein the second filter assembly outlet manifold and the inner conduit of the second filter assembly are configured so that the inner conduit may be removed from the outer conduit of the second filter assembly through the servicing bore.

20. The apparatus as claimed in claim 19 wherein the second filter assembly outlet manifold is further comprised of a servicing bore cap for sealing the servicing bore.

21. The apparatus as claimed in claim 13, further comprising a fluid containment skid, wherein the first filter assembly, the second filter assembly, the bypass assembly, the main inlet manifold, and the main outlet manifold are mounted on the fluid containment skid.

22. A method of filtering debris from a fluid, the method comprising:
(a) providing a first filter assembly, wherein the first filter assembly comprises:
(i) an outer conduit having an outer conduit sidewall and an inner surface defined by the outer conduit sidewall;
(ii) an inner conduit having an inner conduit sidewall and an outer surface defined by the inner conduit sidewall, wherein the inner conduit is received within the outer conduit so that an inner conduit flowpath is defined within the inner conduit and an outer conduit flowpath is defined between the outer surface of the inner conduit sidewall and the inner surface of the outer conduit sidewall, and wherein the inner conduit sidewall is comprised of a filter which permits the fluid to pass between the inner conduit flowpath and the outer conduit flowpath;
(iii) a fluid inlet in communication with the inner conduit flowpath; and
(iv) a fluid outlet in communication with the outer conduit flowpath;
(b) passing the fluid through the first filter assembly;
(c) ceasing passing the fluid through the first filter assembly;
(d) removing the inner conduit of the first filter assembly from within the outer conduit of the first filter assembly;
(e) removing the debris from within the inner conduit of the first filter assembly; and
(f) replacing the inner conduit of the first filter assembly within the outer conduit of the first filter assembly.

23. The method as claimed in claim 22, further comprising:
(g) providing a second filter assembly, wherein the second filter assembly comprises:
(i) an outer conduit having an outer conduit sidewall and an inner surface defined by the outer conduit sidewall;
(ii) an inner conduit having an inner conduit sidewall and an outer surface defined by the inner conduit sidewall, wherein the inner conduit is received within the outer conduit so that an inner conduit flowpath is defined within the inner conduit and an outer conduit flowpath is defined between the outer surface of the inner conduit sidewall and the inner surface of the outer conduit sidewall, and wherein the inner conduit sidewall is comprised of a filter which permits the fluid to pass between the inner conduit flowpath and the outer conduit flowpath;
(iii) a fluid inlet in communication with the inner conduit flowpath; and
(iv) a fluid outlet in communication with the outer conduit flowpath;
(h) providing a control system for selectively controlling a passage of the fluid through the first filter assembly and the second filter assembly;
(i) actuating the control system to pass the fluid only through the second filter assembly;
(j) passing the fluid through the second filter assembly;
(k) actuating the control system to pass the fluid only through the first filter assembly;
(l) removing the inner conduit of the second filter assembly from within the outer conduit of the second filter assembly;
(m) removing the debris from within the inner conduit of the second filter assembly; and
(n) replacing the inner conduit of the second filter assembly within the outer conduit of the second filter assembly.

24. The method as claimed in claim 23, further comprising:
(o) providing a bypass assembly, wherein the bypass assembly comprises:
(i) a bypass conduit defining a bypass flowpath;
(ii) a fluid inlet in communication with the bypass flowpath; and
(iii) a fluid outlet in communication with the bypass flowpath;
(p) actuating the control system to pass the fluid only through the bypass assembly; and
(q) passing the fluid through the bypass assembly.
